(19) United States
(12) Patent Application Publication
(10) Pub. No.: US 2023/0338895 A1
(43) Pub. Date: Oct. 26, 2023

(54) CARBON DIOXIDE RECOVERY SYSTEM

(71) Applicant: DENSO CORPORATION, Kariya-city (JP)

(72) Inventor: Yuta NISHIWAKI, Kariya-city (JP)

(21) Appl. No.: 18/303,601

(22) Filed: Apr. 20, 2023

(30) Foreign Application Priority Data
Apr. 25, 2022 (JP) 2022-071449

(51) Int. Cl. B01D 53/32; B01D 53/62; B01D 53/96; B01D 53/34

(52) U.S. Cl. CPC B01D 53/326; B01D 53/62; B01D 53/965; B01D 53/346; B01D 2257/504

(57) ABSTRACT

A controller unit is configured to control a recovery unit, an expeller unit, a collector unit and a connector unit. The controller unit is configured to place each of a first collector opening and closing device, a second collector opening and closing device and an expeller opening and closing device in a closed state and place a connector opening and closing device in an opened state and thereafter operate the expeller unit to expel a remaining gas from a collector pipe through a connector pipe and an expeller pipe to execute an exhausting process before the controller unit executes a recovering process by desorbing carbon dioxide from an electrochemical cell device and collecting the carbon dioxide at a utilization unit through the collector pipe after the desorbing of the carbon dioxide from the electrochemical cell device.

### CROSS REFERENCE TO RELATED APPLICATION

This application is based on and incorporates herein by reference Japanese Patent Application No. 2022-71449 filed on Apr. 25, 2022.

### TECHNICAL FIELD

The present disclosure relates to a carbon dioxide recovery system.

### BACKGROUND

Previously, there has been proposed a carbon dioxide recovery system. In the carbon dioxide recovery system, carbon dioxide, which undergoes a reduction reaction, is supplied to an electrolyte working electrode, and a substance, which undergoes an oxidation reaction, is supplied to a counter electrode.

In the carbon dioxide recovery system, the carbon dioxide is adsorbed at the working electrode by controlling a voltage applied between the working electrode and the counter electrode. Furthermore, the carbon dioxide is desorbed from the working electrode by controlling the voltage applied between the working electrode and the counter electrode.

A recovery unit for recovering the carbon dioxide includes: an electrochemical cell device which includes the working electrode and the counter electrode; and a housing which receives the electrochemical cell device. A remaining gas, more specifically the air is expelled from an inside of the housing before the carbon dioxide is desorbed from the electrochemical cell device. In this way, the inside of the housing becomes a vacuum state. Thereafter, the carbon dioxide is desorbed from the electrochemical cell device and is collected at a utilization unit for utilizing the carbon dioxide through a pipe.

### SUMMARY

This section provides a general summary of the disclosure, and is not a comprehensive disclosure of its full scope or all of its features.

According to the present disclosure, there is provided a carbon dioxide recovery system that includes a recovery unit, an expeller unit, a collector unit, a connector unit and a controller unit. The recovery unit includes an electrochemical cell device and a housing that receives the electrochemical cell device. The expeller unit includes an expeller pipe and an expeller opening and closing device. The collector unit includes a utilization unit, a collector pipe, a first collector opening and closing device and a second collector opening and closing device. The connector unit includes a connector pipe and a connector opening and closing device.

The controller unit is configured to control the recovery unit, the expeller unit, the collector unit and the connector unit. The controller unit is configured to place each of the first collector opening and closing device, the second collector opening and closing device and the expeller opening and closing device in a closed state and place the connector opening and closing device in an opened state and thereafter operate the expeller unit to expel a remaining gas from the collector pipe through the connector pipe and the expeller pipe to execute an exhausting process before the controller unit executes a recovering process by desorbing the carbon dioxide from the electrochemical cell device and collecting the carbon dioxide at the utilization unit through the collector pipe after the desorbing of the carbon dioxide from the electrochemical cell device.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram indicating a carbon dioxide recovery system of a first embodiment.

FIG. 2 is a diagram for explaining an exhausting process.

FIG. 3 is a diagram for explaining an adsorbing process.

FIG. 4 is a diagram indicating a pressure profile at an inside of a housing at each process.

FIG. 5 is a diagram for explaining a removing process.

FIG. 6 is a diagram for explaining a desorbing process.

FIG. 7 is a diagram for explaining a recovering process.

FIG. 8 is a diagram for explaining a desorbing process of a second embodiment.

FIG. 9 is a diagram for explaining a removing process of a third embodiment.

FIG. 10 is a diagram indicating a carbon dioxide recovery system of a fourth embodiment.

### DETAILED DESCRIPTION

Previously, there has been proposed a carbon dioxide recovery system. In the carbon dioxide recovery system, carbon dioxide, which undergoes a reduction reaction, is supplied to an electrolyte working electrode, and a substance, which undergoes an oxidation reaction, is supplied to a counter electrode.

In the carbon dioxide recovery system, the carbon dioxide is adsorbed at the working electrode by controlling a voltage applied between the working electrode and the counter electrode. Furthermore, the carbon dioxide is desorbed from the working electrode by controlling the voltage applied between the working electrode and the counter electrode.

A recovery unit for recovering the carbon dioxide includes: an electrochemical cell device which includes the working electrode and the counter electrode; and a housing which receives the electrochemical cell device. A remaining gas, more specifically the remaining air is expelled from an inside of the housing before the carbon dioxide is desorbed from the electrochemical cell device. In this way, the inside of the housing becomes a vacuum state. Thereafter, the carbon dioxide is desorbed from the electrochemical cell device and is collected at a utilization unit for utilizing the carbon dioxide through a pipe.

However, with the above collecting method, although the air can be expelled from the inside of the housing, the air is left in a pipe which connects between the housing and the utilization unit. Therefore, at the time of collecting the carbon dioxide at the utilization unit, the air is mixed with the carbon dioxide. Thus, the concentration of the collected carbon dioxide is disadvantageously reduced.

According to one aspect of the present disclosure, there is provided a carbon dioxide recovery system that includes a recovery unit, an expeller unit, a collector unit, a connector unit and a controller unit.

The recovery unit includes: an electrochemical cell device that is configured to adsorb carbon dioxide from a carbon dioxide containing gas, which is a gas containing the carbon dioxide, to recover the carbon dioxide and is configured to desorb the carbon dioxide to enable collection of the carbon dioxide desorbed from the electrochemical cell device; and a housing that receives the electrochemical cell device.

The expeller unit includes: an expeller pipe which connects between an inside and an outside of the housing; and an expeller opening and closing device which is configured to open and close the expeller pipe.

The collector unit includes a utilization unit, a collector pipe, a first collector opening and closing device, and a second collector opening and closing device. The utilization unit is configured to collect the carbon dioxide desorbed from the electrochemical cell device. The collector pipe connects between the inside of the housing and the utilization unit. The first collector opening and closing device is installed to the collector pipe and is configured to open and close the collector pipe at a location that is closer to the housing than to the utilization unit. The second collector opening and closing device is installed to the collector pipe and is configured to open and close the collector pipe at a location that is closer to the utilization unit than to the housing.

The connector unit includes a connector pipe and a connector opening and closing device. The connector pipe connects between: a downstream portion of the expeller pipe which is located on a side of the expeller opening and closing device that is opposite to the housing; and an intermediate portion of the collector pipe which extends from the first collector opening and closing device to the second collector opening and closing device. The connector opening and closing device is configured to open and close the connector pipe.

The controller unit is configured to control the recovery unit, the expeller unit, the collector unit and the connector unit. The controller unit is configured to place each of the first collector opening and closing device, the second collector opening and closing device and the expeller opening and closing device in a closed state and place the connector opening and closing device in an opened state and thereafter operate the expeller unit to expel a remaining gas from the collector pipe through the connector pipe and the expeller pipe to execute an exhausting process before the controller unit executes a recovering process by desorbing the carbon dioxide from the electrochemical cell device and collecting the carbon dioxide at the utilization unit through the collector pipe after the desorbing of the carbon dioxide from the electrochemical cell device.

With the above-described configuration, the remaining gas is expelled from the intermediate portion of the collector pipe before the carbon dioxide is collected at the utilization unit. This makes it difficult for the remaining gas inside the collector pipe to mix with the carbon dioxide gas at the time of collecting the carbon dioxide. Therefore, it is possible to increase the concentration of the carbon dioxide to be collected at the utilization unit.

Hereinafter, embodiments of the present disclosure will be described with reference to the drawings. In each of the following embodiments, portions, which are the same or equivalent to each other, will be indicated by the same reference signs.

### First Embodiment

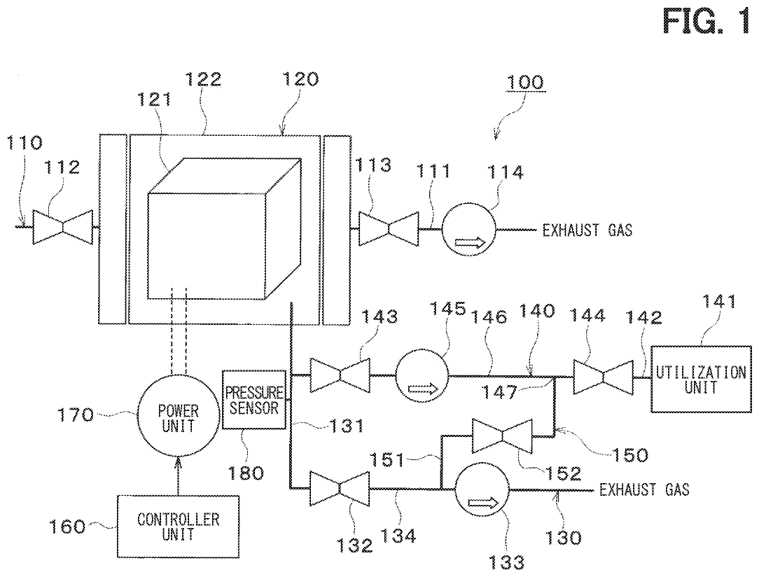

A carbon dioxide recovery system of the present embodiment separates carbon dioxide from a carbon dioxide containing gas (i.e., a gas that contains the carbon dioxide) through an electrochemical reaction. As shown in FIG. 1, the carbon dioxide recovery system 100 includes a duct unit 110, a recovery unit 120, an expeller unit 130, a collector unit 140, a connector unit 150, a controller unit 160, a power unit 170 and a pressure sensor 180.

The duct unit 110 is a device for conducting the carbon dioxide containing gas to the recovery unit 120. The carbon dioxide containing gas is, for example, an atmospheric gas that contains the carbon dioxide. The duct unit 110 includes an introduction pipe 111, a first duct opening and closing device 112, a second duct opening and closing device 113 and a duct pump 114.

The introduction pipe 111 is a pipe for conducing the atmospheric gas to the recovery unit 120. The first duct opening and closing device 112 is installed at a location which is on an upstream side of the recovery unit 120 in the introduction pipe 111. The first duct opening and closing device 112 opens and closes an upstream portion of the introduction pipe 111 according to a command of the controller unit 160. The second duct opening and closing device 113 is installed at a location which is on a downstream side of the recovery unit 120 in the introduction pipe 111. The second duct opening and closing device 113 opens and closes a downstream portion of the introduction pipe 111 according to a command of the controller unit 160. The first duct opening and closing device 112 and the second duct opening and closing device 113 are, for example, valves (a first duct valve and a second duct valve) which open or close a passage of the introduction pipe 111.

The duct pump 114 is installed at a location which is on a downstream side of the second duct opening and closing device 113 in the introduction pipe 111. The duct pump 114 generates a flow of the atmospheric gas in the introduction pipe 111 to supply the atmospheric gas to the recovery unit 120. A blower fan may be used in place of the duct pump 114.

The recovery unit 120 is a device that recovers the carbon dioxide by separating the carbon dioxide from the atmospheric gas. The recovery unit 120 outputs: the rest of the atmospheric gas, from which the carbon dioxide is recovered; or the carbon dioxide, which is recovered from the atmospheric gas. The recovery unit 120 includes an electrochemical cell device 121 and a housing 122.

The electrochemical cell device 121 is configured to adsorb the carbon dioxide from the atmospheric gas to recover the carbon dioxide and is configured to desorb the carbon dioxide to enable collection of the carbon dioxide desorbed from the electrochemical cell device 121. The electrochemical cell device 121 is configured to adsorb and desorb the carbon dioxide through an electrochemical reaction, so that the carbon dioxide can be separated from the atmospheric gas and can be collected.

The electrochemical cell device 121 is an electrochemical cell stack that is a stack of a plurality of cell units each of which includes a working electrode, a counter electrode, an insulating layer and an ion conductive member. The working electrode, the counter electrode and the insulating layer are shaped in a form of a plate. The working electrode is a negative electrode. The counter electrode is a positive electrode.

The working electrode includes a carbon dioxide adsorbent. The carbon dioxide adsorbent is an electroactive species that has a redox activity and can induce a reversible oxidation-reduction reaction. The carbon dioxide adsorbent can bind with the carbon dioxide to adsorb the carbon dioxide in a reduced state and can release the carbon dioxide in an oxidized state. The carbon dioxide adsorbent includes a functional group(s) that can bind with the carbon dioxide. The functional group, which can bind with the carbon dioxide, becomes a carbon dioxide adsorption site at which the carbon dioxide is captured and released.

The working electrode further includes a working electrode side base material, a working electrode side conductive agent and a working electrode side binder besides the carbon dioxide adsorbent. The working electrode side base material is a porous conductive material, through which the carbon dioxide can flow. The working electrode side conductive agent is an electrically conductive substance which forms an electrically conductive path to the carbon dioxide adsorbent. The working electrode side binder is a retaining material that retains the carbon dioxide adsorbent and the working electrode side conductive agent at the working electrode side base material. The carbon dioxide adsorbent, the working electrode side conductive agent and the working electrode side binder are installed at an inside of the porous working electrode side base material.

The counter electrode has a structure that is similar to the structure of the working electrode. The counter electrode includes a counter electrode side active substance. The counter electrode side active substance is a supplementary electroactive species whose redox state is opposite to that of the carbon dioxide adsorbent and transfers electrons to or from the carbon dioxide adsorbent. For example, a metal complex, which enables the electron transfer by changing the valence of metal ions, can be used as the counter electrode side active substance.

The counter electrode includes a counter electrode side base material, a counter electrode side conductive agent and a counter electrode side binder besides the counter electrode side active substance. The counter electrode side base material, the counter electrode side conductive agent and the counter electrode side binder may be the same materials as those employed for the working electrode or may be different from those employed for the working electrode.

The insulating layer is held between the working electrode and the counter electrode. The insulating layer separates between the working electrode and the counter electrode. The insulating layer limits physical contact between the working electrode and counter electrode. The insulating layer also limits electrical short-circuiting between the working electrode and the counter electrode. A separator or a gaseous layer (e.g., an air layer) can be used as the insulating layer.

The ion conductive member is placed between the working electrode and the counter electrode. Specifically, the ion conductive member is placed between the working electrode side base material and the counter electrode side base material via the insulating layer.

The ion conductive member contacts the carbon dioxide adsorbent at an inside of the working electrode side base material. The ion conductive member has ion conductivity. The ion conductive member thereby promotes electrical conduction to the carbon dioxide adsorbent. Ions in the ion conductive member do not react directly with the functional group(s) that binds with the carbon dioxide contained in the carbon dioxide adsorbent. The same material as the working electrode side binder may be used as the ion conductive member, or a different material, which is different from the working electrode side binder, may be used as the ion conductive member.

The housing 122 is a container that receives the electrochemical cell device 121. The housing 122 can be sealed by stopping a flow of the gas with the first duct opening and closing device 112, the second duct opening and closing device 113, the expeller unit 130 and the collector unit 140. The housing 122 may be formed as a part of the introduction pipe 111.

The expeller unit 130 is a device for expelling the remaining gas from the inside of the housing 122 of the recovery unit 120 in a state, in which the carbon dioxide is adsorbed at the electrochemical cell device 121, and the housing 122 is sealed. That is, the expeller unit 130 vacuums the inside of the housing 122.

Here, the state, in which the housing 122 is sealed, refers to a state in which at least the atmospheric gas is not introduced into the inside of the housing 122 through the duct unit 110. In order to expel the gas from the inside of the housing 122 with the expeller unit 130, it is necessary to have a state, in which the sealed housing 122 is communicated with the expeller unit 130. Similarly, in order to collect the carbon dioxide from the recovery unit 120 to the collector unit 140, it is necessary to have a state, in which the sealed housing 122 is communicated with the collector unit 140.

The expeller unit 130 includes an expeller pipe 131, an expeller opening and closing device 132 and an expeller pump 133.

The expeller pipe 131 is a pipe that connects between the inside and the outside of the housing 122. One end portion of the expeller pipe 131 is connected to the housing 122. The other end portion of the expeller pipe 131 is opened to the atmosphere. Therefore, the inside of the housing 122 is communicated with the outside of the housing 122 through the expeller pipe 131. The expeller opening and closing device 132 opens and closes the expeller pipe 131 according to a command of the controller unit 160. The expeller opening and closing device 132 is, for example, a valve (an expeller valve) that opens or closes a passage of the expeller pipe 131.

The expeller pump 133 is installed at a location which is on a downstream side of the expeller opening and closing device 132 in the expeller pipe 131. The expeller pump 133 generates a flow of the gas in the expeller pipe 131 to expel the remaining gas from the inside of the housing 122 at the recovery unit 120. The expeller pump 133 is a dry pump (also referred to as an oil-less pump) or an oil-sealed pump.

The collector unit 140 is a device for collecting the carbon dioxide recovered at the recovery unit 120. The collector unit 140 includes a utilization unit 141, a collector pipe 142, a first collector opening and closing device 143, a second collector opening and closing device 144 and a collector pump 145.

The utilization unit 141 is a device for utilizing the carbon dioxide recovered at the recovery unit 120. The utilization unit 141 collects the carbon dioxide from the recovery unit 120 through the collector pipe 142. The utilization unit 141 is, for example, a tank which stores the carbon dioxide. Instead of the tank, the utilization unit 141 may be a factory or a device which utilize the carbon dioxide.

The collector pipe 142 is a pipe that connects between the inside of the housing 122 and the utilization unit 141. One end portion of the collector pipe 142 is coupled to the one end portion of the expeller pipe 131. Therefore, the one end portion of the collector pipe 142 and the one end portion of the expeller pipe 131 are common. Of course, the one end portion of the collector pipe 142 and the one end portion of the expeller pipe 131 may be independently connected to the housing 122. The other end portion of the collector pipe 142 is coupled to the utilization unit 141. The first collector opening and closing device 143 and the second collector opening and closing device 144 are, for example, valves (a first collector valve and a second collector valve) that open or close a passage of the collector pipe 142.

The first collector opening and closing device 143 is installed to the collector pipe 142 at a location that is closer to the housing 122 than to the utilization unit 141. The first collector opening and closing device 143 opens and closes the collector pipe 142 at the location that is closer to the housing 122 than to the utilization unit 141 according to a command of the controller unit 160. The second collector opening and closing device 144 is installed to the collector pipe 142 at a location that is closer to the utilization unit 141 than to the housing 122. The second collector opening and closing device 144 opens and closes the collector pipe 142 at the location that is closer to the utilization unit 141 than to the housing 122 according to a command of the controller unit 160.

The collector pump 145 is a dry pump for feeding the carbon dioxide, which is recovered at the recovery unit 120, to the utilization unit 141. The collector pump 145 is installed at an intermediate portion 146 of the collector pipe 142 which extends from the first collector opening and closing device 143 to the second collector opening and closing device 144. The collector pump 145 may be installed at the collector pipe 142 at a location between the second collector opening and closing device 144 and the utilization unit 141.

The connector unit 150 is a device that connects between the expeller unit 130 and the collector unit 140. The connector unit 150 includes a connector pipe 151 and a connector opening and closing device 152. One end portion of the connector pipe 151 is connected to the intermediate portion 146 of the collector pipe 142.

Specifically, a joint 147, at which the one end portion of the connector pipe 151 and the intermediate portion 146 of the collector pipe 142 are joined with each other, is placed at a location between the collector pump 145 and the utilization unit 141 in the intermediate portion 146 of the collector pipe 142. The other end portion of the connector pipe 151 is connected to a downstream portion 134 of the expeller pipe 131 which is located on a side of the expeller opening and closing device 132 that is opposite to the housing 122.

Alternatively, the joint 147 may be placed at a location between the first collector opening and closing device 143 and the collector pump 145 in the intermediate portion 146 of the collector pipe 142. In this case, a distance between the collector pump 145 and the utilization unit 141 in the intermediate portion 146 can be reduced.

The connector opening and closing device 152 opens and closes the connector pipe 151 according to a command of the controller unit 160. The connector opening and closing device 152 is, for example, a valve (a connector valve) that opens or closes a passage of the connector pipe 151.

The controller unit 160 includes: a well-known microcomputer, which includes, for example, a CPU (including at least one processor), a ROM, and a RAM; and peripheral circuits thereof. The controller unit 160 (more specifically the CPU) executes various calculations and operations according to a control program stored in the ROM.

The controller unit 160 controls the first duct opening and closing device 112, the second duct opening and closing device 113 and the duct pump 114 installed at the duct unit 110. The controller unit 160 controls the voltage applied to the electrochemical cell device 121 of the recovery unit 120 and also controls the expeller opening and closing device 132 and the expeller pump 133 of the expeller unit 130. The controller unit 160 controls the utilization unit 141, the first collector opening and closing device 143, the second collector opening and closing device 144 and the collector pump 145 of the collector unit 140 and also controls the connector opening and closing device 152 of the connector unit 150.

The power unit 170 is an electric power supply device of the carbon dioxide recovery system 100. The power unit 170 supplies an electric power to the duct unit 110, the recovery unit 120, the expeller unit 130, the collector unit 140, the connector unit 150 and the pressure sensor 180 according to the corresponding command of the controller unit 160. The power unit 170 applies a predetermined voltage to the electrochemical cell device 121 of the recovery unit 120 according to the command of the controller unit 160 to change an electric potential difference between the working electrode and the counter electrode in each cell unit.

The pressure sensor 180 is a device for sensing an internal pressure of the housing 122 at the recovery unit 120. The pressure sensor 180 is installed at the one end portion of the expeller pipe 131. The pressure sensor 180 outputs a measurement signal, which indicates the sensed pressure, to the controller unit 160. The overall structure of the carbon dioxide recovery system 100 of the present embodiment has been described.

Next, the operation of the carbon dioxide recovery system 100 will be described. The controller unit 160 executes an initial process, an adsorbing process, a removing process, a desorbing process and a recovering process to collect the carbon dioxide at the utilization unit 141.

First of all, the controller unit 160 executes the initial process. The initial process is an exhausting process that expels the remaining gas from the collector pipe 142 of the collector unit 140. In the present embodiment, after starting the operation of the carbon dioxide recovery system 100, the initial process is executed once before execution of the adsorbing process.

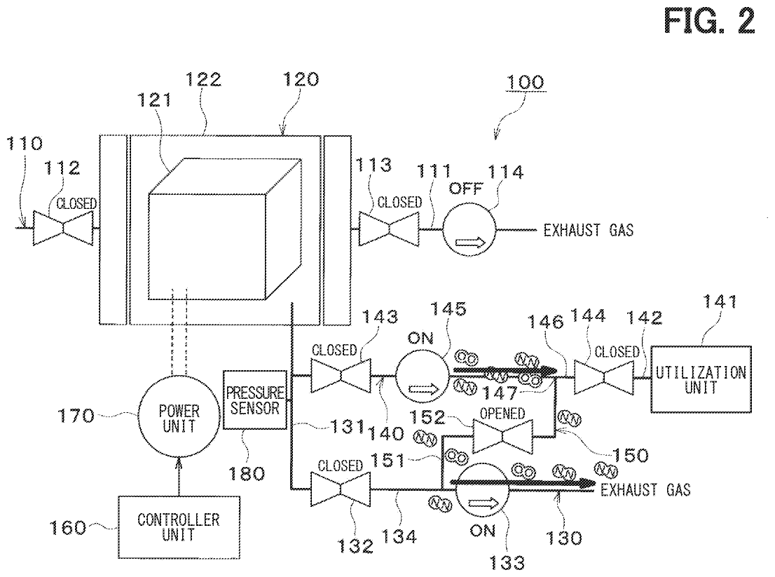

The duct unit 110, the expeller unit 130 and the collector unit 140 are operated in a manner shown in FIG. 2. Specifically, the controller unit 160 controls and places each of the first duct opening and closing device 112, the second duct opening and closing device 113, the expeller opening and closing device 132, the first collector opening and closing device 143 and the second collector opening and closing device 144 in the closed state. Furthermore, the controller unit 160 controls and places the duct pump 114 in the OFF state.

Furthermore, the controller unit 160 controls and places the connector opening and closing device 152 in the opened state and also controls and places each of the expeller pump 133 and the collector pump 145 in the ON state. In this way, the controller unit 160 expels the remaining gas from the intermediate portion 146 of the collector pipe 142 through the connector pipe 151 and the downstream portion 134 of the expeller pipe 131. Furthermore, the controller unit 160 expels the remaining gas from the inside of the collector pump 145 which is the dry pump.

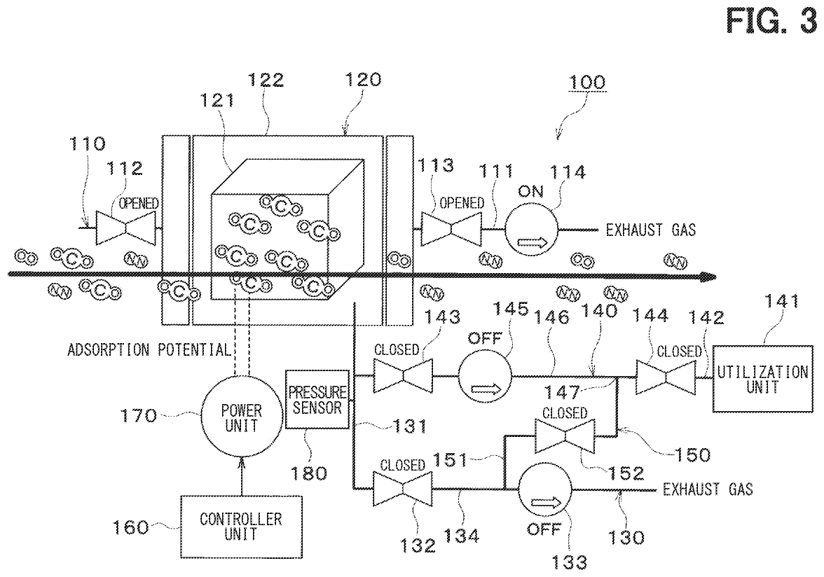

After the initial process, the controller unit 160 executes the adsorbing process that adsorbs the carbon dioxide at the electrochemical cell device 121. Specifically, as shown in FIG. 3, the controller unit 160 controls and places each of the first collector opening and closing device 143, the second collector opening and closing device 144, the connector opening and closing device 152 and the expeller opening and closing device 132 in the closed state. The controller unit 160 controls and places each of the expeller pump 133 and the collector pump 145 in the OFF state.

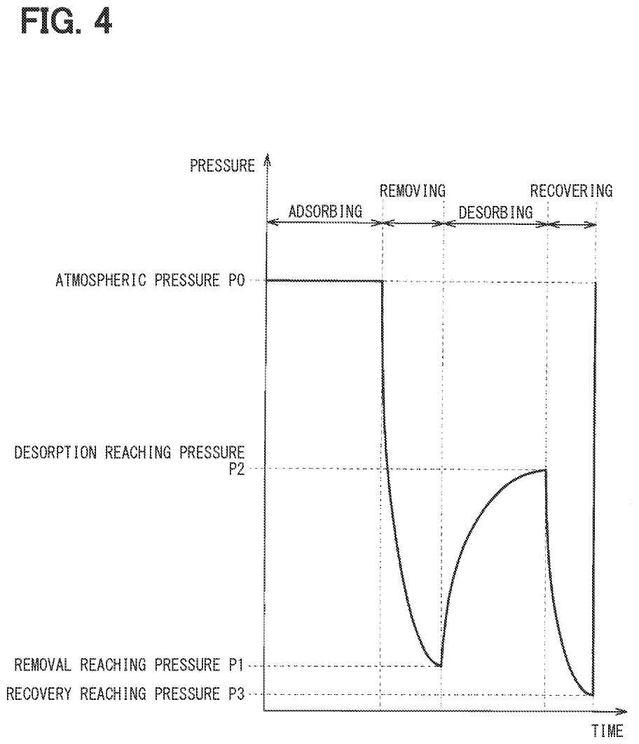

Furthermore, the controller unit 160 controls and places each of the first duct opening and closing device 112 and the second duct opening and closing device 113 in the opened state, and also the controller unit 160 controls and places the duct pump 114 in the ON state. In this way, the atmospheric gas is supplied to the electrochemical cell device 121 of the recovery unit 120. Therefore, as shown in FIG. 4, the pressure at the inside of the housing 122 becomes the atmospheric pressure P0.

The controller unit 160 applies an adsorption potential between the working electrode and the counter electrode of each cell unit at the electrochemical cell device 121 by controlling the power unit 170. Therefore, electron donation by the counter electrode side active substance of the counter electrode and electron attraction by the carbon dioxide adsorbent of the working electrode can be simultaneously implemented.

At the time of applying the adsorption potential between the working electrode and the counter electrode in each cell unit, the counter electrode side active substance releases the electrons and thereby becomes an oxidized state, and the electrons are supplied from the counter electrode to the working electrode. The carbon dioxide adsorbent of the working electrode receives the electrons and thereby becomes a reduced state.

The carbon dioxide adsorbent, which is now in the reduced state, has an increased binding force for the carbon dioxide, so that the carbon dioxide adsorbent is bound with and adsorbs the carbon dioxide contained in the atmospheric gas. As discussed above, when the adsorption potential is applied between the working electrode and the counter electrode in each cell unit of the electrochemical cell device 121, the electrons are supplied from the counter electrode to the working electrode, and the carbon dioxide adsorbent is bound with the carbon dioxide in response to the supply of the electrons. Thereby, the recovery unit 120 can recover the carbon dioxide from the atmosphere.

After the recovering of the carbon dioxide of the atmospheric gas, the rest of the atmospheric gas, which does not contain the carbon dioxide, is expelled from the recovery unit 120. The controller unit 160 terminates the adsorbing process based on, for example, a measurement result of a carbon dioxide sensor (not shown) which is installed at a downstream portion of the introduction pipe 111.

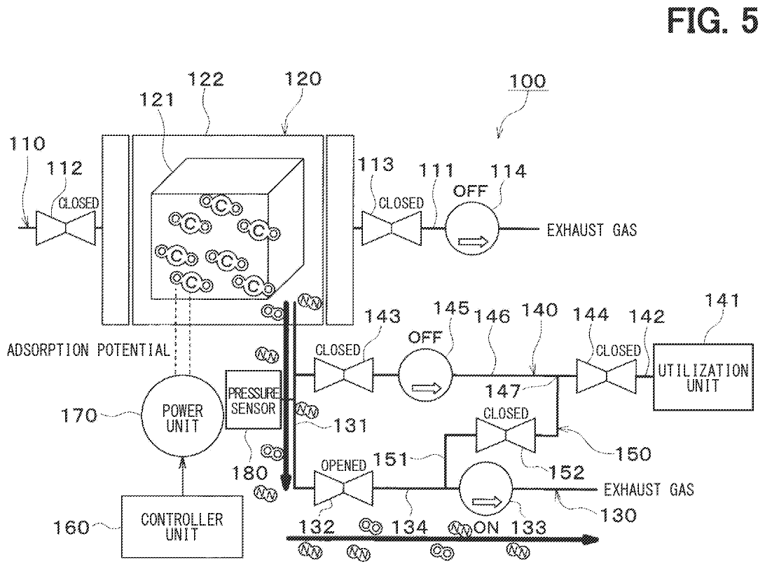

After the adsorbing process, the controller unit 160 executes the removing process that expels the remaining gas from the inside of the housing 122 of the recovery unit 120. In the state where the carbon dioxide is adsorbed at the electrochemical cell device 121, i.e., in the state where the adsorption potential is applied to the electrochemical cell device 121, the controller unit 160 controls and places each of the duct pump 114 and the collector pump 145 in the OFF state, as shown in FIG. 5.

Furthermore, the controller unit 160 controls and places each of the first duct opening and closing device 112, the second duct opening and closing device 113, the first collector opening and closing device 143, the second collector opening and closing device 144 and the connector opening and closing device 152 in the closed state. Furthermore, the controller unit 160 controls and places the expeller opening and closing device 132 in the opened state and controls and places the expeller pump 133 in the ON state.

Therefore, the remaining gas is expelled from the inside of the housing 122 of the recovery unit 120 through the expeller pipe 131. Thus, as shown in FIG. 4, the pressure at the inside of the housing 122 is reduced to a removal reaching pressure P1. The controller unit 160 terminates the removing process at the timing when the pressure at the inside of the housing 122 reaches the removal reaching pressure P1.

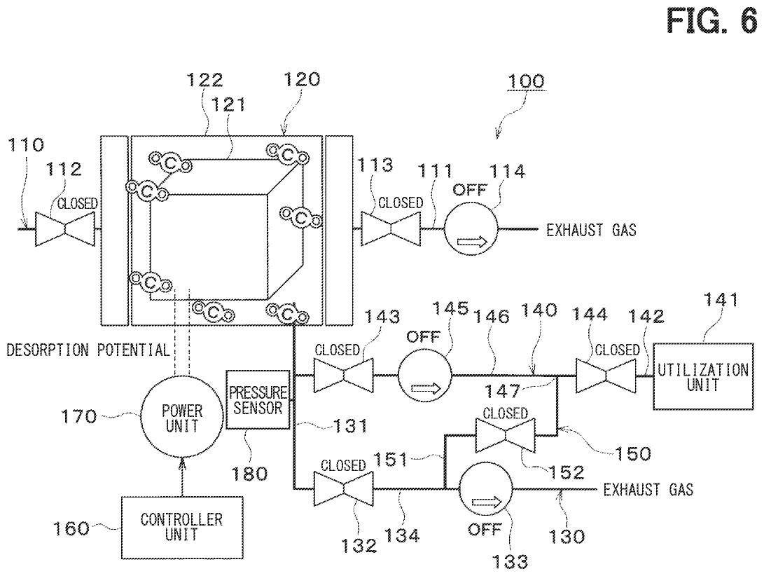

After the removing process, the controller unit 160 executes the desorbing process that desorbs the carbon dioxide which is adsorbed at the electrochemical cell device 121. In the state where the carbon dioxide is adsorbed at the electrochemical cell device 121, the controller unit 160 controls and places each of the duct pump 114, the collector pump 145 and the expeller pump 133 in the OFF state, as shown in FIG. 6.

Furthermore, the controller unit 160 controls and places each of the first duct opening and closing device 112, the second duct opening and closing device 113, the first collector opening and closing device 143, the second collector opening and closing device 144, the connector opening and closing device 152 and the expeller opening and closing device 132 in the closed state.

Then, the controller unit 160 applies a desorption potential between the working electrode and the counter electrode of each cell unit at the electrochemical cell device 121 by controlling the power unit 170. Therefore, electron donation by the carbon dioxide adsorbent of the working electrode and electron attraction by the counter electrode side active substance of the counter electrode can be simultaneously implemented.

The carbon dioxide adsorbent of the working electrode releases the electrons and thereby becomes an oxidized state. The binding force of the carbon dioxide adsorbent for binding with the carbon dioxide is reduced, so that the carbon dioxide adsorbent desorbs and releases the carbon dioxide. The counter electrode side active substance of the counter electrode receives the electrons and thereby becomes the reduced state.

The carbon dioxide is desorbed from the electrochemical cell device 121 in the above-described manner. The carbon dioxide is released at the inside of the housing 122. Thus, as shown in FIG. 4, the pressure at the inside of the housing 122 is increased to a desorption reaching pressure P2 at the end time of the desorbing process.

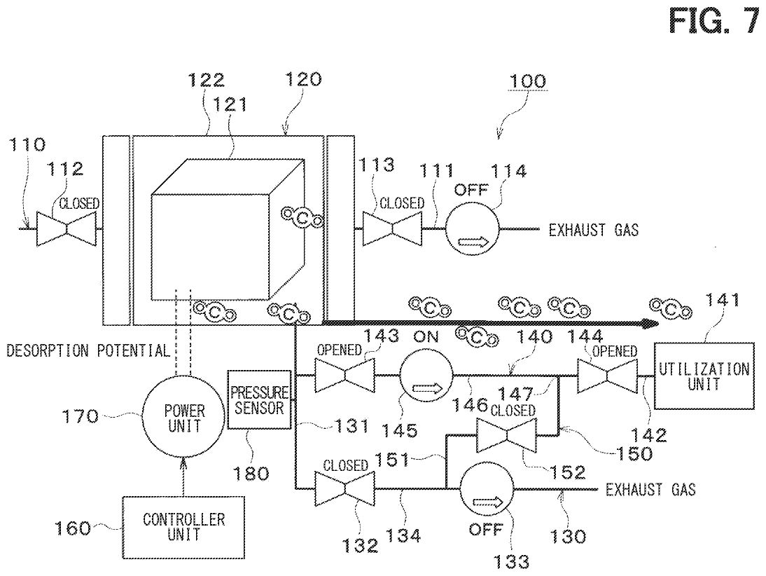

After the desorbing process, the controller unit 160 executes the recovering process that recovers the carbon dioxide which is desorbed from the electrochemical cell device 121. As shown in FIG. 7, in the state where the carbon dioxide is desorbed from the electrochemical cell device 121, the controller unit 160 controls and places each of the first duct opening and closing device 112, the second duct opening and closing device 113, the connector opening and closing device 152 and the expeller opening and closing device 132 in the closed state. Furthermore, the controller unit 160 controls and places each of the duct pump 114 and the expeller pump 133 in the OFF state.

Furthermore, the controller unit 160 controls and places each of the first collector opening and closing device 143 and the second collector opening and closing device 144 in the opened state and also controls and places the collector pump 145 in the ON state. Thereby, the carbon dioxide, which is released from the carbon dioxide adsorbent, is outputted from the recovery unit 120 and is collected at the utilization unit 141 through the collector pipe 142.

During the period of collecting the carbon dioxide at the utilization unit 141, the collector pump 145 is driven. Thus, as shown in FIG. 4, the pressure at the inside of the housing 122 is reduced to a recovery reaching pressure P3. The pressure at the inside of the housing 122 returns to the atmospheric pressure P0 by shifting the process to the adsorbing process after the recovering process.

The adsorbing process, the removing process, the desorbing process and the recovering process constitute one cycle. The controller unit 160 repeats the cycle. When the controller unit 160 executes the initial process, i.e., the exhausting process once, at least the intermediate portion 146 of the collector pipe 142 becomes a vacuum state. Furthermore, after an initial recovering process of an initial cycle among a plurality of cycles, at least the intermediate portion 146 of the collector pipe 142 is filled with the carbon dioxide gas. Therefore, at each of the second and further cycles, it is not required to execute the exhausting process. Of course, when the inside of the intermediate portion 146 of the collector pipe 142 returns to have the atmospheric gas after the termination of the consecutive operation of the cycles, the initial process may be executed at the time of restarting the consecutive operation of the cycle.

As described above, in the present embodiment, the exhausting process, which expels the remaining gas from the collector pipe 142, is executed before the execution of the recovering process that collects the carbon dioxide at the utilization unit 141 through the collector pipe 142 after desorption of the carbon dioxide from the electrochemical cell device 121. Thereby, the remaining gas is expelled from at least the intermediate portion 146 in the collector pipe 142, so that the remaining gas in the inside of the collector pipe 142 is less likely to be mixed with the carbon dioxide gas. Therefore, it is possible to increase the concentration of the carbon dioxide to be collected at the utilization unit 141.

Particularly, in a case where a length of the collector pipe 142 is relatively long, the amount of the remaining gas left in the collector pipe 142 becomes large. Even in such a case, the concentration of the collected carbon dioxide can be increased. In order to expel the remaining gas from the collector pipe 142 as much as possible, it is preferable that the first collector opening and closing device 143 is placed closer to the housing 122 as much as possible, and the second collector opening and closing device 144 is placed closer to the utilization unit 141 as much as possible. Here, it is preferable that the connector opening and closing device 152 is placed closer to the joint 147 as much as possible.

Furthermore, in the case of executing the consecutive operation of the cycles, it is only required to execute the exhausting process once before the adsorbing process, so that the exhausting process does not need to be carried out every time during the consecutive operation of the cycles. Of course, the exhausting process may be carried out every time before each cycle, or the exhausting process may be carried out once every two or more cycles.

Furthermore, since the dry pump is used as the collector pump 145, the remaining gas can be expelled from the inside of the collector pump 145 during the exhausting process. Therefore, the carbon dioxide having the higher concentration can be collected.

### Second Embodiment

In the present embodiment, points, which are different from the first embodiment, will be mainly described. In the present embodiment, the controller unit 160 executes the exhausting process after the removing process. In this way, the advantages, which are similar to those of the first embodiment, can be achieved.

Specifically, the adsorbing process, the removing process, the exhausting process, the desorbing process and the recovering process constitute one cycle. That is, the controller unit 160 executes the exhausting process after the removing process and executes the desorbing process after the exhausting process.

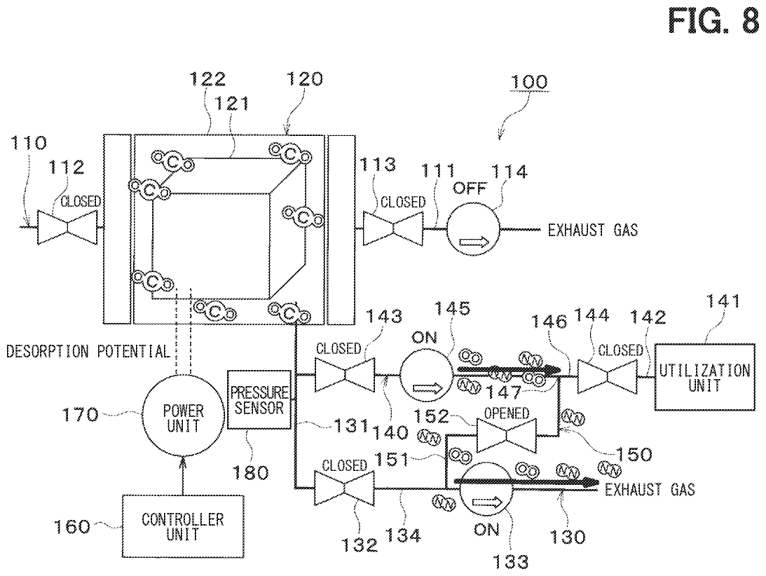

Alternatively, the controller unit 160 simultaneously executes the exhausting process during the desorbing process. Specifically, the adsorbing process, the removing process, the desorbing process (the exhausting process) and the recovering process constitute one cycle. In this case, during the desorbing process, the controller unit 160 controls and places the connector opening and closing device 152 in the opened state and also controls and places each of the expeller pump 133 and the collector pump 145 in the ON state, as shown in FIG. 8. Since there is no need to execute the exhausting process alone, the time required for the exhausting process is eliminated.

The exhausting process does not need to be carried out after the removing process every time during the consecutive operation of the cycles. The exhausting process may be carried out after the removing process at each of the plurality of cycles.

### Third Embodiment

In the present embodiment, points, which are different from the first and second embodiments, will be mainly described. In the present embodiment, the controller unit 160 simultaneously executes the removing process and the exhausting process at the time of executing the removing process. That is, the adsorbing process, the removing process (the exhausting process), the desorbing process and the recovering process constitute one cycle.

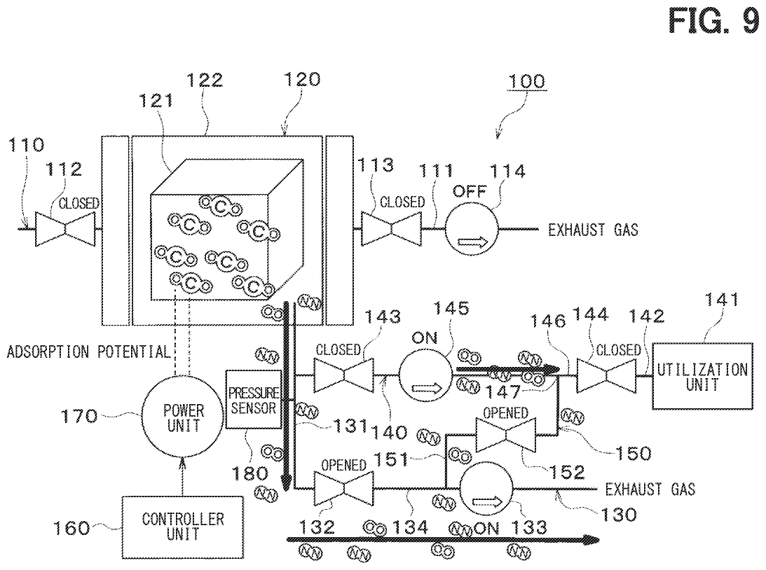

Specifically, as shown in FIG. 9, in the states of the opening and closing devices 112, 113, 132, 143, 144, 152 and the states of the pumps 114, 133, 145 at the removing process, the controller unit 160 controls and places the connector opening and closing device 152 from the closed state to the opened state. Furthermore, the controller unit 160 controls and places the collector pump 145 in the ON state.

Specifically, in other words, in the states of the opening and closing devices 112, 113, 132, 143, 144, 152 and the states of the pumps 114, 133, 145 at the exhausting process, the controller unit 160 controls and places the expeller opening and closing device 132 from the closed state to the opened state.

Here, at the exhausting process and the removing process, the first collector opening and closing device 143 is placed in the closed state. However, in the case of simultaneously executing the exhausting process and the removing process, the first collector opening and closing device 143 may be placed either the closed state or the opened state.

In this way, the advantages, which are similar to those of the first embodiment, can be achieved. Furthermore, since the exhausting process can be executed during the removing process, the time for executing the exhausting process is not required.

### Fourth Embodiment

In the present embodiment, points, which are different from the above-described respective embodiments, will be mainly described. In the present embodiment, an oil-sealed pump is used as the collector pump 145 of the collector unit 140.

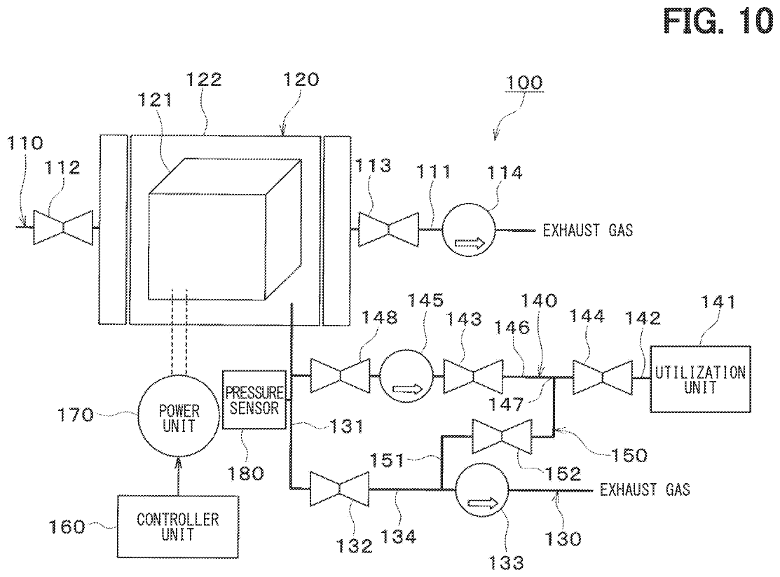

In this case, as shown in FIG. 10, the collector unit 140 includes a third collector opening and closing device 148. The third collector opening and closing device 148 is, for example, a valve (a third collector valve) that opens or closes the passage of the collector pipe 142. The third collector opening and closing device 148 is placed on the upstream side of the collector pump 145. Furthermore, the first collector opening and closing device 143 is placed on the downstream side of the collector pump 145.

At the time of executing the exhausting process and the removing process, the controller unit 160 controls and places each of the third collector opening and closing device 148 and the first collector opening and closing device 143 in the closed state. In this way, the oil is not expelled from the collector pump 145 which is the oil-sealed pump. Furthermore, at the time of executing the recovering process, the controller unit 160 controls and places each of the third collector opening and closing device 148 and the first collector opening and closing device 143 in the opened state and also controls and places the collector pump 145 in the ON state.

As described above, in the case where the collector pump 145, which is the oil-sealed pump, is used, the third collector opening and closing device 148 is provided. Therefore, at the time of executing the exhausting process and the removing process, it is possible to limit leakage of the oil of the collector pump 145 which is the oil-sealed pump.

### Other Embodiments

The structure of the carbon dioxide recovery system 100 described in each of the above-described embodiments is one example. The present disclosure is not limited to such a structure, and the structure of the carbon dioxide recovery system 100 described in each of the above-described embodiments may be changed to any other structure that can implement the present disclosure. For example, the carbon dioxide containing gas is not limited to the atmospheric gas and may be any gas that contains the carbon dioxide.

Furthermore, the carbon dioxide recovery system 100 may not include the duct unit 110. In such a case, the housing 122 of the recovery unit 120 may have a door that can be opened and closed to enable capturing and sealing of the atmospheric gas. In a case where the carbon dioxide recovery system 100 is set at the outdoor, the natural wind passes through the inside of the housing 122.

Each of the opening and closing devices 112, 113, 132, 143, 144, 148, 152 described in the above embodiments may be any type of valve, such as an electric ON-OFF valve (e.g., electric ball, plug, butterfly, gate, and globe valves) or an electric control valve.

The controllers (the controller units) and methods described in the present disclosure may be implemented by a special purpose computer created by configuring a memory and at least one processor programmed to execute one or more particular functions embodied in computer programs. Alternatively, the controllers and methods described in the present disclosure may be implemented by a special purpose computer created by configuring at least one processor provided by one or more special purpose hardware logic circuits. Alternatively, the controllers and methods described in the present disclosure may be implemented by one or more special purpose computers created by configuring a combination of a memory and at least one processor programmed to execute one or more particular functions and at least one processor provided by one or more hardware logic circuits. The computer programs may be stored, as instructions being executed by a computer, in a tangible non-transitory computer-readable medium.

What is claimed is:

1. A carbon dioxide recovery system comprising:
a recovery unit that includes:
an electrochemical cell device that is configured to adsorb carbon dioxide from a carbon dioxide containing gas, which is a gas containing the carbon dioxide, to recover the carbon dioxide and is configured to desorb the carbon dioxide to enable collection of the carbon dioxide desorbed from the electrochemical cell device; and
a housing that receives the electrochemical cell device;
an expeller unit that includes:
an expeller pipe which connects between an inside and an outside of the housing; and
an expeller opening and closing device which is configured to open and close the expeller pipe;
a collector unit that includes:
a utilization unit which is configured to collect the carbon dioxide desorbed from the electrochemical cell device;
a collector pipe which connects between the inside of the housing and the utilization unit;
a first collector opening and closing device which is installed to the collector pipe and is configured to open and close the collector pipe at a location that is closer to the housing than to the utilization unit; and
a second collector opening and closing device which is installed to the collector pipe and is configured to open and close the collector pipe at a location that is closer to the utilization unit than to the housing;
a connector unit that includes:
a connector pipe which connects between:
a downstream portion of the expeller pipe which is located on a side of the expeller opening and closing device that is opposite to the housing; and
an intermediate portion of the collector pipe which extends from the first collector opening and closing device to the second collector opening and closing device; and
a connector opening and closing device which is configured to open and close the connector pipe; and
a controller unit that is configured to control the recovery unit, the expeller unit, the collector unit and the connector unit, wherein:
the controller unit is configured to place each of the first collector opening and closing device, the second collector opening and closing device and the expeller opening and closing device in a closed state and place the connector opening and closing device in an opened state and thereafter operate the expeller unit to expel a remaining gas from the collector pipe through the connector pipe and the expeller pipe to execute an exhausting process before the controller unit executes a recovering process by desorbing the carbon dioxide from the electrochemical cell device and collecting the carbon dioxide at the utilization unit through the collector pipe after the desorbing of the carbon dioxide from the electrochemical cell device.

2. The carbon dioxide recovery system according to claim 1, wherein the controller unit is configured to execute the exhausting process before the controller unit executes an adsorbing process that adsorbs the carbon dioxide at the electrochemical cell device.

3. The carbon dioxide recovery system according to claim 1, wherein the controller unit is configured to execute the exhausting process after the controller unit executes a removing process that expels the remaining gas from the inside of the housing through the expeller pipe in a state where the carbon dioxide is adsorbed at the electrochemical cell device.

4. The carbon dioxide recovery system according to claim 1, wherein the controller unit is configured to simultaneously execute both:
a removing process that expels the remaining gas from the inside of the housing at a time of executing the exhausting process by controlling the expeller opening and closing device from the closed state to an opened state and operating the expeller unit; and
the exhausting process.

5. The carbon dioxide recovery system according to claim 1, wherein:
the collector unit includes a collector pump that is a dry pump and is installed at the collector pipe at a location between the first collector opening and closing device and a joint of the collector pipe which is joined to the connector pipe, wherein the collector pump is configured to feed the carbon dioxide to the utilization unit; and
the controller unit is configured to expel the remaining gas from the intermediate portion of the collector pipe and also expel the remaining gas from an inside of the collector pump at the exhausting process.

6. A carbon dioxide recovery system comprising:
a recovery unit that includes:
an electrochemical cell device that is configured to adsorb carbon dioxide from a carbon dioxide containing gas, which is a gas containing the carbon dioxide, to recover the carbon dioxide and is configured to desorb the carbon dioxide to enable collection of the carbon dioxide desorbed from the electrochemical cell device; and
a housing that receives the electrochemical cell device;
an expeller unit that includes:
an expeller pipe which connects between an inside and an outside of the housing; and
an expeller valve which is configured to open and close the expeller pipe;
a collector unit that includes:
a utilization unit which is configured to collect the carbon dioxide desorbed from the electrochemical cell device;
a collector pipe which connects between the inside of the housing and the utilization unit;
a first collector valve which is installed to the collector pipe and is configured to open and close the collector pipe at a location that is closer to the housing than to the utilization unit; and
a second collector valve which is installed to the collector pipe and is configured to open and close the collector pipe at a location that is closer to the utilization unit than to the housing;
a connector unit that includes:
a connector pipe which connects between:
a downstream portion of the expeller pipe which is located on a side of the expeller valve that is opposite to the housing; and
an intermediate portion of the collector pipe which extends from the first collector valve to the second collector valve; and
a connector valve which is configured to open and close the connector pipe; and
at least one processor that is configured to control the recovery unit, the expeller unit, the collector unit and the connector unit, wherein:
the at least one processor is configured to place each of the first collector valve, the second collector valve and the expeller valve in a closed state and place the connector valve in an opened state and thereafter turn on an expeller pump of the expeller unit installed at the expeller pipe to expel a remaining gas from the collector pipe through the connector pipe and the expeller pipe to execute an exhausting process before the at least one processor executes a recovering process by desorbing the carbon dioxide from the electrochemical cell device and collecting the carbon dioxide at the utilization unit through the collector pipe after the desorbing of the carbon dioxide from the electrochemical cell device.
